(19) United States
(12) Patent Application Publication
(10) Pub. No.: US 2019/0166543 A1
(43) Pub. Date: May 30, 2019

(54) MINIMIZING DISTRACTIONS OF MACHINE OPERATORS CAUSED BY USING A MOBILE DEVICE IN A WIRELESS COMMUNICATION NETWORK

(71) Applicant: T-Mobile USA, Inc., Bellevue, WA (US)

(72) Inventor: Ahmad Arash Obaidi, San Ramon, CA (US)

(21) Appl. No.: 15/822,975

(22) Filed: Nov. 27, 2017

(51) Int. Cl. H04W 48/04; H04M 1/725; H04W 4/02

(52) U.S. Cl. CPC H04W 48/04; H04K 3/415; H04W 4/027; H04M 1/72577

(57) ABSTRACT

A method of controlling features and functions of a mobile device via a feature control application executing on the mobile device operating in a wireless communication network. The method includes determining, by the feature control application, if a user of the mobile device is an operator of a machine. Based at least in part on determining if the user is the operator of the machine, the feature control application determines if the machine is operating in a safe mode of operation. Based at least in part on determining if the machine is operating in the safe mode of operation, the feature control application determines which features of the mobile device to allow the user to operate.

### BACKGROUND

In recent years, mobile telecommunication devices have advanced from offering simple voice calling services within wireless networks to providing users with many new features. Mobile telecommunication devices now provide messaging services such as email, text messaging, and instant messaging; data services such as Internet browsing; media services such as storing and playing a library of favorite songs; location services; and many others. In addition to the new features provided by the mobile telecommunication devices, users of such mobile telecommunication devices have greatly increased. Such an increase in users is only expected to continue and in fact, it is expected that there could be a growth rate of twenty times more users in the next few years alone.

Unfortunately, as mobile devices have continually increased in the services they provide and their popularity, use of mobile devices while operating machines, e.g., motor vehicles, planes, trains, heavy equipment, food processing equipment, etc., has also increased. Use of mobile devices by operators of machines can lead to the operators being distracted. Such distraction is dangerous and can lead to accidents that can have serious consequences.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIGS. 1A and 1B schematically illustrate a wireless communication network, in accordance with various embodiments.

FIG. 2 is a flowchart illustrating a method of controlling features and functions of a mobile device via a feature control application executing on the mobile device operating in the wireless communication network of FIGS. 1A and 1B, in accordance with various embodiments.

FIG. 3 schematically illustrates a component level view of an example mobile device configured for use in the wireless communication networks of FIGS. 1A and 1B.

FIG. 4 schematically illustrates a component level view of a server configured for use in the arrangements of FIGS. 1A and 1B to provide various services of the wireless communication network of FIGS. 1A and 1B.

### DETAILED DESCRIPTION

Described herein is a wireless communication network and mobile devices for use in the wireless communication network that include techniques and architecture for controlling operation of features and functions on the mobile devices based upon the user operating a machine while attempting to use a mobile device. For example, a user's mobile device may include a feature control application that may control operation of features on the user's mobile device based upon the user operating a machine. The controlling of the features may be based, at least in part, on a mode of operation of the machine.

More particularly, when a user of a mobile device is operating a machine, a feature control application on the mobile device may determine that the user is operating the machine. The feature control application may make this determination based upon communication with one or more components of the machine. For example, the machine may be configured as an Internet of Things (IoT) device, or the machine may include one or more components configured as IoT devices. Thus, the machine, or one or more components of the machine, may be capable of communicating with various other devices. Generally, Internet of Things refers to a network of physical objects—devices, vehicles, buildings and other items embedded with electronics, software, sensors, and network connectivity—that enables these objects to collect and exchange data. IoT allows objects to be sensed and controlled remotely across existing network infrastructure, creating opportunities for more direct integration of the physical world into computer-based systems, and resulting in improved efficiency, accuracy and economic benefit. When IoT is augmented with sensors and actuators, the technology becomes an instance of the more general class of cyber-physical systems, which also encompasses technologies such as smart grids, smart homes, intelligent transportation and smart cities. Each thing is uniquely identifiable through its embedded computing system, but is able to interoperate within the existing Internet infrastructure.

Based at least in part on the determination that the user is operating the machine, the feature control application may also determine whether the machine is operating in a safe mode of operation. For example, if the machine is a motor vehicle, then a safe mode of operation may be that the motor vehicle is in park. If the motor vehicle is operating and is in park, then all features and functions of the mobile device may be accessible for use by the user of the mobile device. If, however, the motor vehicle is operating and is not in park, then the motor vehicle may not be deemed to be operating in the safe mode of operation and thus, one or more features and/or functions of the mobile device may be disabled for operation by the feature control application.

As an example, if the machine is a motor vehicle, distracted driving may occur if the user is texting, snap-chatting, video chatting, taking pictures, etc., while driving. Thus, if the feature control application determines that the motor vehicle is operating and the motor vehicle is not in a safe mode of operation, e.g., in park, then the feature control application may prevent the user from accessing and operating such features of the mobile device. In configurations, the feature control application may determine that the mobile device is coupled to a hands-free device, e.g., a head piece or ear piece, via, for example, a Bluetooth connection. Thus, based at least in part on such a determination, the feature control application may allow the mobile device to receive and place phone calls via the hand-free device. Otherwise, the mobile device may only be allowed to place emergency calls. Additionally, if the feature control application determines that the motor vehicle is in operation and not in a safe mode of operation, then all features of the mobile device may be disabled except for a map function and/or placing of emergency calls.

In order to determine that the operator of the mobile device is operating a machine, the feature control application may communicate with an electronic control module of the motor vehicle in order to determine if the motor vehicle is indeed operating and if the motor vehicle is in a safe mode of operation, e.g., in park. For example, the electronic control module may be configured as an IoT device and thus broadcasting information for other IoT devices to receive.

Additionally, the feature control application may determine if the user of the mobile device is actually the operator of the motor vehicle. For example, the feature control application may utilize a camera on the mobile device in order to determine the proximity of the mobile device to a component of the motor vehicle, e.g., the steering wheel or steering column. If the feature control application determines that the mobile device is in close proximity to the steering column, then the feature control application may determine that the user of the mobile device is also the operator of the motor vehicle. However, if the feature control application determines that the user of the mobile device is not in close proximity to the steering column, e.g., the user is sitting in the passenger seat or in the back seat of the motor vehicle, then the feature control application may determine that the user is not the operator of the motor vehicle and may allow access and operation of all functions in features of the mobile device to the user.

Other examples of determining if the motor vehicle is moving, e.g., not in a safe mode of operation, may include utilizing a GPS feature of the mobile device and may also include determining a height of the mobile device, e.g., in order to determine if the user of the mobile device is walking and not driving a motor vehicle. As another example, the speedometer of the motor vehicle may also be configured as an IoT device and thus, may be able to communicate with the mobile device and the feature control application.

In configurations, if the machine does not include components configured as IoT devices, then the feature control application may access a database of the machine, e.g., a motor vehicle, in order to determine various components necessary for operation of the machine. Based upon the components, the feature control application may utilize a sonar feature of the mobile device in order to determine proximity of the mobile device to the components of the machine. If, based upon use of the sonar, the feature control application determines that the mobile device is in close proximity to the machine, then the feature control application may limit use and operation of various features and functions of the mobile device.

Other examples of determining if the motor vehicle is moving, e.g., not in a safe mode of operation, may include utilizing a GPS feature of the mobile device and may also include determining a height of the mobile device, e.g., in order to determine if the user of the mobile device is walking or driving the motor vehicle. As another example, the speedometer of the motor vehicle may also be configured as an IoT device and thus, may be able to communicate with the mobile device and the feature control application.

In configurations, permissions may be provided by a database operated by an operator of the wireless communication network in order to provide permissions to the feature control application with respect to which circumstances and modes of operation of various machines various features and functions of the mobile device may be permitted by the feature control application. Additionally, a third party may provide additional permissions or alter permissions provided by the database to the feature control application. For example, a parent may further limit various permissions for the mobile device in order to limit use of the mobile device by a child.

While various examples have been described with respect to a motor vehicle, other types of machines may also limit the features and functions accessible by a user of a mobile device that includes the feature control application during operation of a machine. For example, a pilot, an operator of a train, a butcher operating a meat slicer, factory workers operating heavy machinery or small devices in the factory, operators of heavy equipment, e.g., construction equipment, etc., may include (or their employer may include) and utilize the feature control application on their mobile device to help prevent distracted operation of the machine based upon use of the mobile device while operating the machine. Additionally, a machine itself may include the feature control application and utilize the feature control application to determine if an operator of the machine is using a mobile device while the machine is operating in an unsafe mode of operation and thereby control features of the mobile device as described herein.

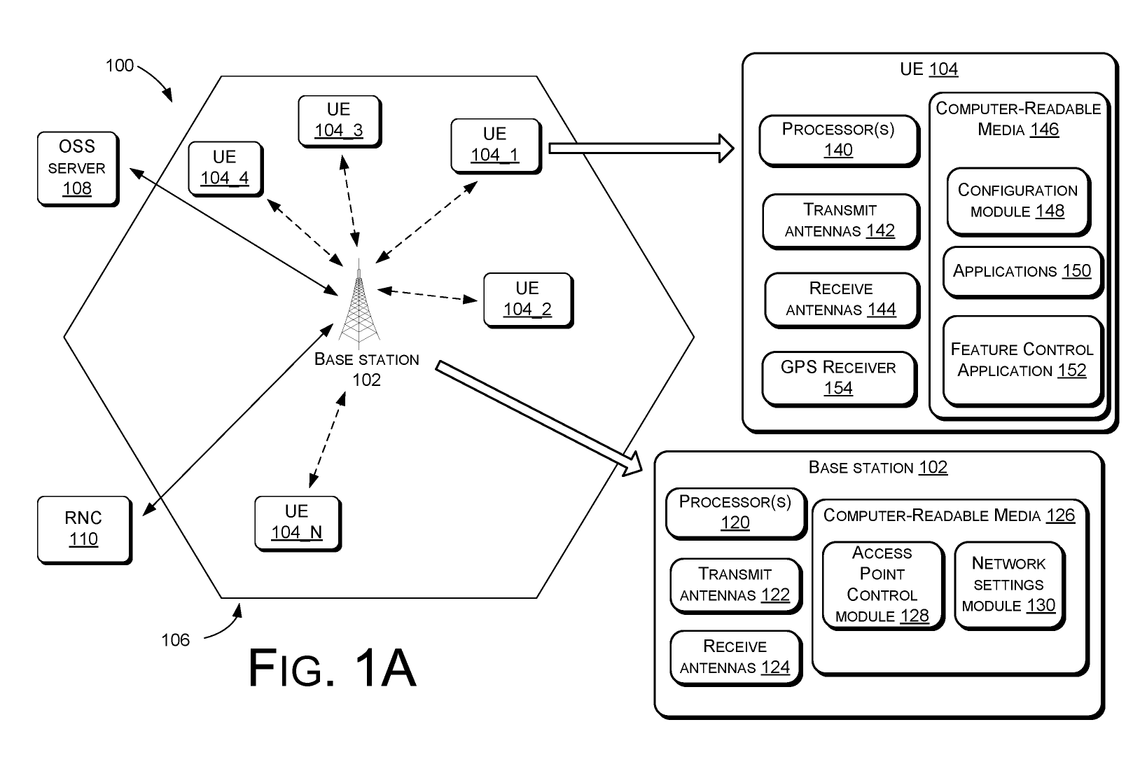

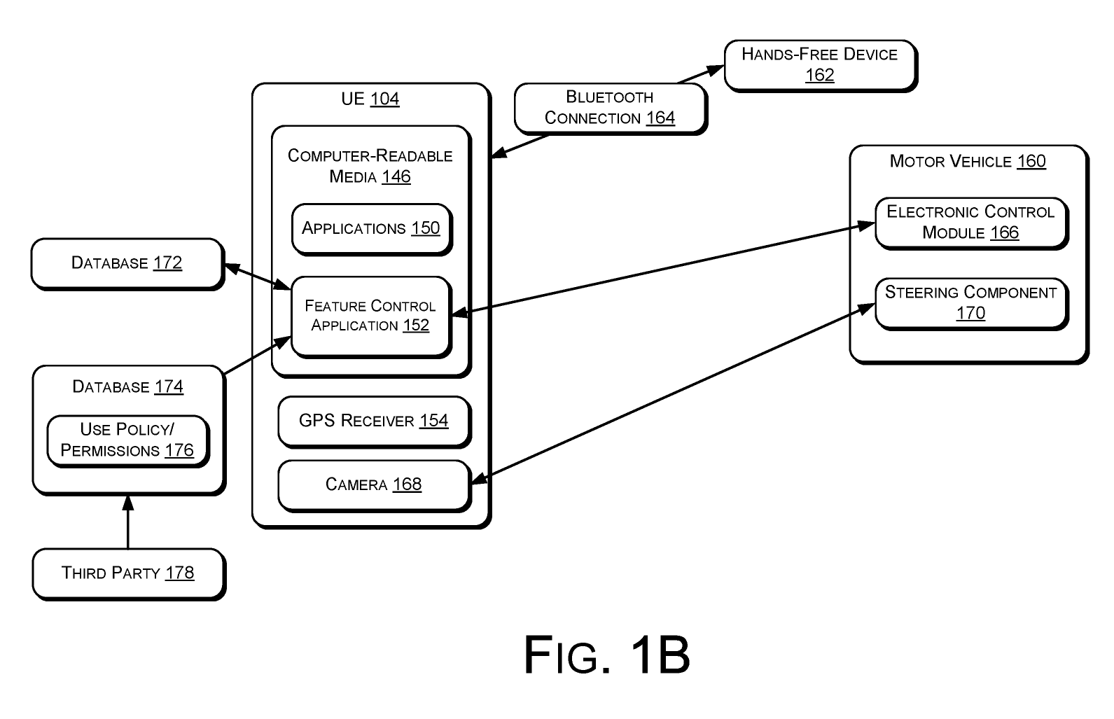

FIG. 1A illustrates a wireless communication network 100 (also referred to herein as network 100). The network 100 comprises a base station (BS) 102 communicatively coupled to a plurality of user devices, referred to as UEs 104_1, 104_2, . . . , 104_N, where N is an appropriate integer. The BS 102 serves UEs 104 located within a geographical area, e.g., within a macro cell 106. FIG. 1A illustrates the macro cell 106 to be hexagonal in shape, although other shapes of the macro cell 106 may also be possible. In general, the network 100 comprises a plurality of macro cells 106, with each macro cell 106 including one or more BSs 102. In configurations, the macro cells 106 may be divided into small cells (not illustrated), e.g., femto cells, pico cells, micro cells, or the like. The multiple macro cells 106 and small cells may be organized into multiple subnetworks that make up the wireless communication network 100. For example, the wireless communication network 100 may be a national network and thus, the wireless communication network 100 may be divided into four regional subnetworks, where each regional subnetwork includes multiple macro cells 106 that may be divided into small cells.

In an embodiment, the UEs 104_1, . . . , 104_N may comprise any appropriate devices, e.g., portable electronic devices, for communicating over a wireless communication network. Such devices include mobile telephones, cellular telephones, mobile computers, Personal Digital Assistants (PDAs), radio frequency devices, handheld computers, laptop computers, tablet computers, palmtops, pagers, devices configured as IoT devices, integrated devices combining one or more of the preceding devices, and/or the like. As such, UEs 104_1, . . . , 104_N may range widely in terms of capabilities and features. For example, one of the UEs 104_1, . . . , 104_N may have a numeric keypad, a capability to display only a few lines of text and be configured to interoperate with only Global System for Mobile Communications (GSM) networks. However, another of the UEs 104_1, . . . , 104_N (e.g., a smart phone) may have a touch-sensitive screen, a stylus, an embedded GPS receiver, and a relatively high-resolution display, and be configured to interoperate with multiple types of networks. UEs 104_1, . . . , 104_N may also include SIM-less devices (i.e., mobile devices that do not contain a functional subscriber identity module (“SIM”)), roaming mobile devices (i.e., mobile devices operating outside of their home access networks), and/or mobile software applications.

In an embodiment, the BS 102 may communicate voice traffic and/or data traffic with one or more of the UEs 104_1, . . . , 104_N. The BS 102 may communicate with the UEs 104_1, . . . , 104_N using one or more appropriate wireless communication protocols or standards. For example, the BS 102 may communicate with the UEs 104_1, . . . , 104_N using one or more standards, including but not limited to GSM, Internet Protocol (IP) Multimedia Subsystem (IMS), Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), Wi-Fi protocols (including IEEE 802.11 protocols), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like.

The BS 102 may be communicatively coupled (e.g., using a backhaul connection, illustrated using solid lines in FIG. 1A) to a number of backhaul equipments, e.g., an operation support subsystem (OSS) server 108, a radio network controller (RNC) 110, and/or the like. The RNC 110 can also be in the form of a mobility management entity that serves as a gateway when the wireless communication network 100 operates according to the long term evolution (LTE) standard or LTE Advanced standard.

The BS 102 may also be communicatively coupled to a public safety answering point (PSAP)/emergency service responder 112 (referred to herein as PSAP 112). As is known, a PSAP generally is a call center responsible for answering calls to an emergency telephone number for police, firefighting and ambulance services. Trained telephone operators are usually responsible for dispatching these emergency service. The PSAP 112 is configured to receive communications from UEs 104 (e.g., 911 calls), where a user of a UE 104 is requesting emergency services, e.g., ambulance services, police services, firefighting services, etc.

In an embodiment, the base station 102 may comprise processors 120, one or more transmit antennas (transmitters) 122, one or more receive antennas (receivers) 124, and computer-readable media 126. The processors 120 may be configured to execute instructions, which may be stored in the computer-readable media 126 or in other computer-readable media accessible to the processors 120. In some embodiments, the processors 120 are a central processing unit (CPU), a graphics processing unit (GPU), or both CPU and GPU, or any other sort of processing unit. The base station 102 can also be in the form of a Node B (where the wireless communication network 100 is 3G UMTS network) or in the form of an eNode B (where the wireless communication network 100 operates according to the LTE standard or LTE Advanced standard).

The one or more transmit antennas 122 may transmit signals to the UEs 104_1, . . . , 104_N, and the one or more receive antennas 124 may receive signals from the UEs 104_1, . . . , 104_N. The antennas 122 and 124 include any appropriate antennas known in the art. For example, antennas 122 and 124 may include radio transmitters and radio receivers that perform the function of transmitting and receiving radio frequency communications. In an embodiment, the antennas 122 and 124 may be included in a transceiver module of the BS 102.

The computer-readable media 126 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the base station 102. The computer-readable media 126 may reside within the base station 102, on one or more storage devices accessible on a local network to the base station 102, on cloud storage accessible via a wide area network to the base station 102, or in any other accessible location.

The computer-readable media 126 may store modules, such as instructions, data stores, and so forth that are configured to execute on the processors 120. For instance, the computer-readable media 126 may store an access point control module 128 and a network settings module 130, as will be discussed in more detail herein later.

Although FIG. 1A illustrates the computer-readable media 126 in the BS 102 storing the access point control module 128 and the network settings module 130, in various other embodiments, the access point control module 128, the network settings module 130, and one or more other modules (not illustrated, may be stored in another component of the network 100 (e.g., other than the BS 102). For example, one or more of these modules may be stored in a computer-readable media included in the OSS server 108, the RNC 110, another appropriate server associated with the network 100, and/or the like.

Although not illustrated in FIG. 1A, various other modules (e.g., an operating system module, basic input/output systems (BIOS), etc.) may also be stored in the computer-readable media 126. Furthermore, although not illustrated in FIG. 1A, the base station 102 may comprise several other components, e.g., a power bus configured to supply power to various components of the base station 102, one or more interfaces to communicate with various backhaul equipment, and/or the like.

In an embodiment, the UEs 104 may comprise processors 140, one or more transmit antennas (transmitters) 142, one or more receive antennas (receivers) 144, and computer-readable media 146 in the form of memory and/or cache. The processors 140 may be configured to execute instructions, which may be stored in the computer-readable media 146 or in other computer-readable media accessible to the processors 140. In some embodiments, the processors 140 is a central processing unit (CPU), a graphics processing unit (GPU), or both CPU and GPU, or any other sort of processing unit. The one or more transmit antennas 142 may transmit signals to the base station 102, and the one or more receive antennas 144 may receive signals from the base station 102. In an embodiment, the antennas 142 and 144 may be included in a transceiver module of the UE 104.

The computer-readable media 146 may also include CRSM. The CRSM may be any available physical media accessible by a computing device to implement the instructions stored thereon. CRSM may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which can be used to store the desired information and which can be accessed by the UE 104.

The computer-readable media 146 may store several modules, such as instructions, data stores, and so forth that are configured to execute on the processors 140. For instance, the computer-readable media 140 may store a configuration module 148. In configurations, the computer-readable media 146 may also store one or more applications 150 configured to receive and/or provide voice, data and messages (e.g., short message service (SMS) messages, multi-media message service (MMS) messages, instant messaging (IM) messages, enhanced message service (EMS) messages, etc.) to and/or from another device or component (e.g., the base station 102, other UEs, etc.). In a configuration, the computer-readable media 146 may store a feature control application 152, as will be described further herein. The applications 150 may also include third-party applications that provide additional functionality to the UE 104. In configurations, the UE 104 may also comprise a Global Positioning System (GPS) receiver 154 and/or another location determination component.

Although not illustrated in FIG. 1A, the UEs 104 may also comprise various other components, e.g., a battery, a charging unit, one or more network interfaces, an audio interface, a display, a keypad or keyboard, and other input and/or output interfaces.

Although FIG. 1A illustrates only one UE (UE 104_1) in detail, each of the UEs 1042, . . . , 104_N may have a structure that is at least in part similar to that of the UE 104_1. For example, similar to the UE 104_1, each of the UEs 104_2, . . . , 104_N may comprise processors, one or more transmit antennas, one or more receive antennas, and computer-readable media including a configuration module.

In an embodiment, the network settings module 130 stored in the computer-readable media 126 maintains a plurality of network settings associated with the network 100. Individual network settings maintained by the network settings module 130 may be pertinent to a single UE of the UEs 104_1, . . . , 104_N, a subset of the UEs 104_1, . . . , 104_N, or each of the UEs 104_1, . . . , 104_N. For example, a network setting of the plurality of network settings may specify a maximum bit rate at which a UE (or each of the UEs 104_1, . . . , 104_N) may transmit data to the BS 102. Another network setting of the plurality of network settings may specify a transmit time interval (tti) used by each of the UEs 104_1, . . . , 104_N to transmit data to the BS 102. Yet another network setting of the plurality of network settings may specify a maximum power that each of the UEs 104_1, . . . , 104_N may use to transmit data to the BS 102. The plurality of network settings maintained by the network settings module 130 may also include any other appropriate type of network settings.

In an embodiment, one or more of the plurality of network settings maintained by the network settings module 13 may be communicated to the UEs 104_1, . . . , 104_N (e.g., by the transmit antennas 122 to the receive antennas 144 of the UEs 104_1, . . . , 104_N). Based on receiving the network settings, the UEs 104_1, . . . , 104_N (e.g., the corresponding configuration modules 148) may configure themselves and communicate with the BS 102 accordingly.

In configurations, when a user of a UE 104 is operating a machine, the feature control application 152 on the UE 152 may determine that the user is operating the machine. The feature control application 152 may make this determination based upon communication with one or more components of the machine. For example, the machine may be configured as an Internet of Things (IoT) device, or the machine may include one or more components configured as IoT devices. Thus, the machine, or one or more components of the machine, may be capable of communicating with various other devices that are configured as IoT devices or are configured to communicate with IoT devices.

Based at least in part on the determination that the user is operating the machine, the feature control application 152 may also determine whether the machine is operating in a safe mode of operation. For example, if the machine is a motor vehicle, then a safe mode of operation may be that the motor vehicle is in park. If the motor vehicle is operating and is in park, then all features of the UE 104 may be accessible for use by the user of the UE 104. For example, the user may be able to use the UE 104 to place and receive calls, send text messages, access the Internet, etc. If, however, the motor vehicle is operating and is not in park, then the motor vehicle may not be deemed to be operating in a safe mode of operation and thus, one or more features and/or functions of the UE 104 may be disabled for operation by the feature control application 152.

FIG. 1B schematically illustrates an arrangement of a UE 104 interacting with a machine, e.g., a motor vehicle 160, via the wireless communication network 100 of FIG. 1A. The UE 104 generally includes many of the previously mentioned components and/or features. However, for simplicity, the UE 104 is only illustrated as including applications 150 and the feature control application 152 located in the computer-readable media 146, the GPS receiver 154, and a camera 168.

More particularly, as an example, if the machine is a motor vehicle 160, distracted driving may occur if the user is texting, snap-chatting, video chatting, taking pictures, etc., while driving. Thus, if the feature control application 152 determines that the motor vehicle 160 is operating and the motor vehicle 160 is not in a safe mode of operation, e.g., in park, then the feature control application 152 may prevent the user from accessing and operating such features of the UE 104. However, in configurations, the feature control application 152 may determine that the UE 104 is coupled to a hands-free device 162, e.g., a head piece or ear piece, via, for example, a Bluetooth connection 164. Thus, based at least in part on such a determination, the feature control application 152 may allow the UE 104 to receive and place phone calls via the hand-free device 162. Otherwise, the UE 104 may only be allowed to place emergency calls. Additionally, if the feature control application 152 determines that the motor vehicle 160 is in operation and not in a safe mode of operation, then all features of the UE 104 may be disabled except for, in configurations, a map function or map application and/or placing of emergency calls.

In order to determine that the operator of the UE 104 is operating the motor vehicle 160, the feature control application 152 may communicate with an electronic control module 166 of the motor vehicle 160 in order to determine if the motor vehicle 160 is indeed operating and if the motor vehicle 160 is operating in a safe mode of operation, e.g., in park. For example, the electronic control module 166 may be configured as an IoT device and thus broadcasting information for other IoT capable devices, e.g., the UE 104, to receive.

Additionally, the feature control application 152 may determine if the user of the UE 104 is actually the operator of the motor vehicle 160. For example, the feature control application 152 may utilize the camera 168 on the UE 104 in order to determine the proximity of the UE 104 to a steering component 170 of the motor vehicle 160, e.g., a steering wheel or steering column. If the feature control application 152 determines that the UE 104 is in close proximity to the steering component 170, then the UE 104 may determine that the user of the UE 104 is also the operator of the motor vehicle 160. However, if the feature control application 152 determines that the user of the UE 104 is not in close proximity to the steering component 170, e.g., the user is sitting in a passenger seat or in a back seat of the motor vehicle 160, then the UE 104 may determine that the user is not the operator of the motor vehicle 160 and may allow access and operation of all functions in features of the UE 104 to the user.

In configurations, another example of determining if the motor vehicle 160 is moving, e.g., not in a safe mode of operation, may include utilizing a GPS feature of the UE 104 provided by the GPS receiver 154. This may also include determining a height of the UE 104 relative to ground in order to determine if the user of the UE 104 is actually walking and not driving the motor vehicle 160, e.g., not located in the motor vehicle 160, based on the height of the UE 104. As another example, a speedometer (not illustrated) of the motor vehicle 160 may also be configured as an IoT device and thus, may be able to communicate with the UE 104 and the feature control application 152.

In configurations, the feature control application 152 may access a database 172 of the manufacturer of the motor vehicle 160 (or other entity that includes the database 172) that includes information pertaining to various components of the motor vehicle 160. In situations where the motor vehicle does not include any components configured as IoT devices, e.g., the electronic control module 166, the steering component 170, a speedometer, etc., the feature control application 152 may access a database 172 to obtain information relating to components of the motor vehicle 160. For example, the feature control application 152 may obtain information relating to the location of the steering component 170 of the motor vehicle 160. The feature control application 152 may then use the camera 168 to provide a line of sight between the steering component 170 and the UE 104. A sonar feature of the UE 104 or a radar feature of the UE 104 may then be used to determine proximity, e.g., distance, of the UE 104 with respect to the steering component 170 in order to determine if the operator of the UE 104 is also the driver of the motor vehicle 160.

In configurations, a use policy and/or permissions 174 may be provided by a server 176 operated by an operator of the wireless communication network 100 in order to provide permissions 174 to the feature control application 152 to thereby define under which circumstances and modes of operation of various machines various features and/or functions of the UE 104 may be permitted by the feature control application 152. The use policy and/or permissions 174 may be based, at least in part, on local, state and/or federal laws. In configurations, when the use policy and/or permissions 174 are updated, the use policy and/or permissions may be pushed onto UEs 104. Additionally, a third party 178 may provide additional permissions 174 or alter permissions 174 provided by the server 176 to the feature control application 152 via an admin portal. For example, a parent may further limit various permissions 174 for the UE 104 in order to limit use of the UE 104 by a child in various circumstances.

While various examples have been described with respect to a motor vehicle 160, other types of machines may also limit the features and functions accessible by a user of a UE 104 that includes the feature control application 152 during operation of other types of machines as described herein. For example, a pilot of an airplane, an operator of a train, an operator of a boat or ship, a butcher operating a meat slicer, factory workers operating heavy machinery or small devices in a factory, operators of heavy equipment, e.g., construction equipment, etc., may include (or their employer may include) and utilize the feature control application 152 on their UE 104 to help prevent distracted operation of the machine based upon use of the UE 104 while operating the machine. Additionally, a machine itself may include the feature control application 152 (or similar application) and utilize the feature control application 152 to determine if an operator of the machine is using a UE 104 while the machine is operating in an unsafe mode of operation and thereby control features of the UE 104 as described herein.

Thus, by utilizing the feature control application 152 on the UE 104, use of various features and/or functions of the UE 104 may be limited or disabled when a user of the UE 104 is operating a machine. This can help reduce or even eliminate distracted operation of the machine by the user of the UE 104, thereby improving safety for the user of the UE 104 as well as others in close proximity to the machine.

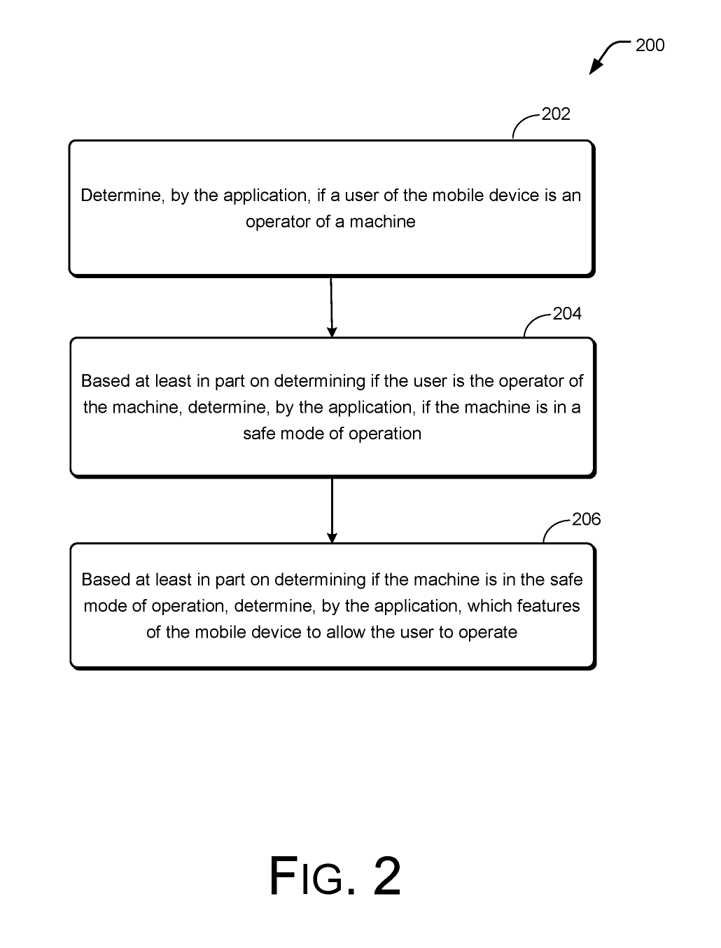

FIG. 2 is a flow diagram of an illustrative process that may be implemented within the wireless communication network 100. This process (as well as other processes described throughout) are illustrated as a logical flow graph, each operation of which represents a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Furthermore, while the architectures and techniques described herein have been described with respect to wireless networks, the architectures and techniques are equally applicable to processors and processing cores in other environments and computing devices.

FIG. 2 is a flowchart illustrating a method 200 of controlling features and functions of a mobile device, e.g., UE 104, via an application, e.g., feature control application 152, executing on the mobile device operating in a wireless communication network, e.g., wireless communication network 100. As illustrated, at block 202, the application determines if a user of the mobile device is an operator of a machine, e.g., motor vehicle 160. At block 204, based at least in part on determining if the user is the operator of the machine, the application determines if the machine is operating in a safe mode of operation. At block 206, based at least in part on determining if the machine is operating in the safe mode of operation, the application determines which features of the mobile device to allow the user to operate.

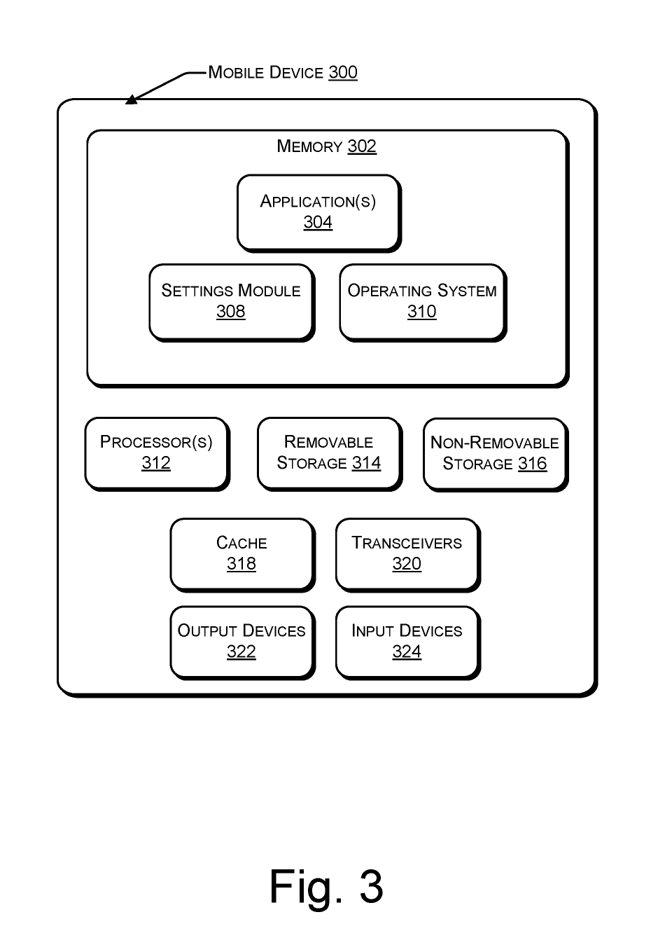

FIG. 3 schematically illustrates a component level view of a mobile device 300, such as UE 104, configured to function within wireless communication network 100. As illustrated, the mobile device 300 comprises a system memory 302, e.g. computer-readable media 146, storing application(s) 304, e.g., applications 150 and feature control application 152, a settings module 308, and an operating system 310. Also, the mobile device 300 includes processor(s) 312, a removable storage 314, a non-removable storage 316, transceivers 318, output device(s) 320, and input device(s) 322. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit.

The mobile device 300 may also include additional data storage devices (removable and/or non-removable) such as, for example, magnetic disks, optical disks, or tape. Such additional data storage may include removable storage 314 and non-removable storage 316. Additionally, the mobile device 300 includes cache 318, such as cache 156, for storing one or more locations of the mobile device 300.

Non-transitory computer-readable media may include volatile and nonvolatile, removable and non-removable tangible, physical media implemented in technology for storage of information, such as computer readable instructions, data structures, program modules, or other data. System memory 302, removable storage 314, non-removable storage 316 and cache 318 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the user device 300. Any such non-transitory computer-readable media may be part of the user device 300. The processor(s) 312 may be configured to execute instructions, which may be stored in the non-transitory computer-readable media or in other computer-readable media accessible to the processor(s) 312.

In some implementations, the transceivers 320 include any sort of transceivers known in the art. For example, the transceivers 320 may include a radio transceiver that performs the function of transmitting and receiving radio frequency communications via an antenna. Also or instead, the transceivers 320 may include wireless modem(s) to may facilitate wireless connectivity with other computing devices. Further, the transceivers 320 may include wired communication components, such as an Ethemet port, for communicating with other networked devices.

In some implementations, the output devices 322 include any sort of output devices known in the art, such as a display (e.g., a liquid crystal display), speakers, a vibrating mechanism, or a tactile feedback mechanism. Output devices 322 also include ports for one or more peripheral devices, such as headphones, peripheral speakers, or a peripheral display.

In various implementations, input devices 324 include any sort of input devices known in the art. For example, input devices 324 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 324 may be used to enter preferences of a user of the mobile device 300 to define how the user wishes certain calls from third parties to be handled by the wireless communication network, as previously described herein.

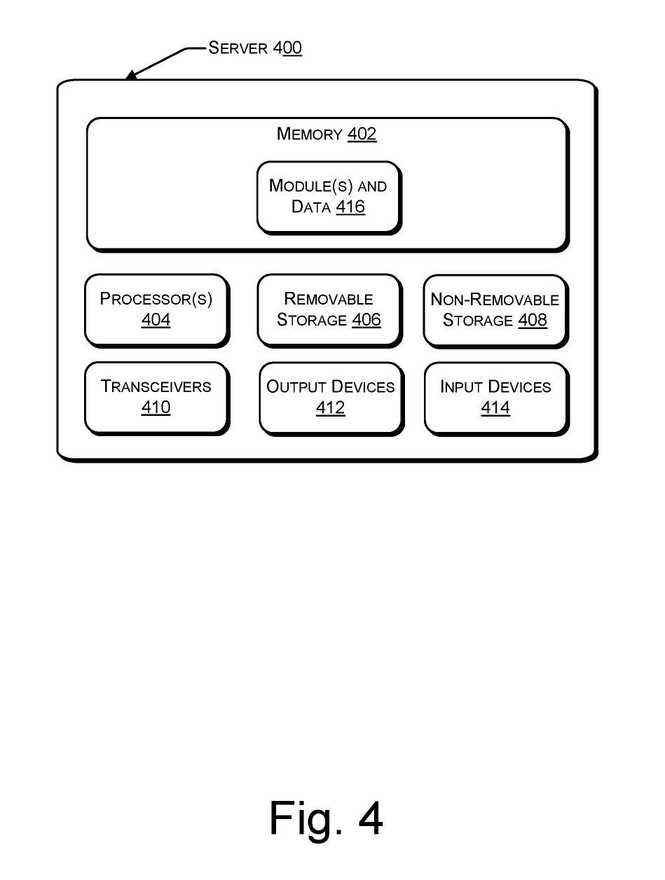

FIG. 4 illustrates a component level view of a server configured for use within a wireless communication network, e.g., wireless communication network 100 in order to provide various services within the wireless communication network, according to the techniques described herein. The server 400 may serve as the OSS server 108 or may be located in the RNC or gateway 110. Additionally, the server 400 may serve as the server 176 that includes the use policy and/or permissions 174 for operation of mobile devices, e.g., UEs 104, in the wireless communication network 100.

As illustrated, the server 400 comprises a system memory 402 that may store data and one or more modules and/or applications 416 for interacting with mobile devices 300, e.g., UEs 104, as described herein. Also, the server 400 includes processor(s) 404, a removable storage 406, a non-removable storage 408, transceivers 410, output device(s) 412, and input device(s) 414.

In various implementations, system memory 402 is volatile (such as RAM), non-volatile (such as ROM, flash memory, etc.) or some combination of the two. In some implementations, the processor(s) 404 is a central processing unit (CPU), a graphics processing unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 406 and non-removable storage 408. The one or more of the memory 402, the removable storage 406 and/or the non-removable 408 may include module(s) and data 416 (illustrated in the memory 402). The module(s) and data 416 may include instructions executable by, for example, the processors 404.

Non-transitory computer-readable media may include volatile and nonvolatile, removable and non-removable tangible, physical media implemented in technology for storage of information, such as computer readable instructions, data structures, program modules, or other data. System memory 402, removable storage 406 and non-removable storage 408 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 410 include any sort of transceivers known in the art. For example, the transceivers 410 may include wired communication components, such as an Ethernet port, for communicating with other networked devices. Also or instead, the transceivers 410 may include wireless modem(s) to may facilitate wireless connectivity with other computing devices. Further, the transceivers 410 may include a radio transceiver that performs the function of transmitting and receiving radio frequency communications via an antenna.

In some implementations, the output devices 412 include any sort of output devices known in the art, such as a display (e.g., a liquid crystal display), speakers, a vibrating mechanism, or a tactile feedback mechanism. Output devices 412 also include ports for one or more peripheral devices, such as headphones, peripheral speakers, or a peripheral display.

In various implementations, input devices 414 include any sort of input devices known in the art. For example, input devices 414 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method of controlling operation of a mobile device via an application executing on the mobile device operating in a wireless communication network, the method comprising:
determining, by the application, when a user of the mobile device is an operator of a machine comprising a motor vehicle;
based at least in part on determining when the user is the operator of the machine, determining, by the application, when the machine is operating in a safe mode of operation, wherein the safe mode of operation comprises the machine operating and being not in gear; and
based at least in part on determining when the machine is operating in the safe mode of operation, preventing operation of one or more features of the mobile device while providing access to features for communicating with a public safety answering point (PSAP) for emergency services.

2. (canceled)

3. The method of claim 1, wherein based at least in part on (i) determining that the user is the operator of the machine and (ii) determining that the machine is not operating in the safe mode of operation, determining which features of the mobile device to allow the user to operate comprises:
determining, by the application, when the mobile device is operating in a hands-free mode of operation; and
based at least in part on determining when the mobile device is operating in a hands-free mode of operation, allowing one or more features of the mobile device relating to calls.

4. The method of claim 1, wherein determining when the user of the mobile device is the operator of the machine comprises:
identifying, by the application, a component of the machine; and
determining, by the application, a distance of the mobile device from the component.

5. The method of claim 4, wherein the component comprises a steering component, and wherein determining the distance of the mobile device from the component comprises:
identifying the steering component of the motor vehicle utilizing a line of sight feature of the mobile device; and
determining the distance of the mobile device from the steering component utilizing a sonar feature of the mobile device.

6. The method of claim 5, further comprising:
accessing, by the application, a database that includes information related to components of the motor vehicle.

7. The method of claim 1, wherein determining which features of the mobile device to allow the user to operate comprises:
allowing the user to operate all features of the mobile device when the motor vehicle is determined to be operating in the safe mode of operation.

8. The method of claim 1, wherein determining which features of the mobile device to allow the user to operate comprises:
determining which features of the mobile device to allow the user to operate based upon permissions received by the application from a database.

9. The method of claim 8, wherein the database is operated by an operator of the wireless communication network.

10. The method of claim 8, further comprising:
receiving, from a third party, additional permissions by the application.

11. A mobile device configured for operation in a wireless communication network, the mobile device comprising:
a camera;
one or more processors;
a non-transitory storage medium; and
instructions stored in the non-transitory storage medium, the instructions being executable by the one or more processors to:
access a database that includes information related to components of the machine;
based at least in part on accessing the database, identify a component of the machine;
based at least in part on identifying the component of the machine, determine when a user of the mobile device is an operator of a machine detecting, via the camera, a distance of the mobile device from the component;
based at least in part on determining when the user is the operator of the machine, determine when the machine is operating in a safe mode of operation; and
based at least in part on determining when the machine is operating in the safe mode of operation, determine which features of the mobile device to allow the user to operate.

12. The mobile device of claim 11, wherein based at least in part on (i) determining that the user is the operator of the machine and (ii) determining that the machine is not operating in the safe mode of operation, and wherein the instructions are further executable by the one or more processors to:
prevent operation of all features of the mobile device other than contacting emergency services.

13. The mobile device of claim 11, wherein the machine is a motor vehicle and wherein based at least in part on (i) determining that the user is the operator of the machine and (ii) determining that the machine is not operating in the safe mode of operation, and wherein the instructions are further executable by the one or more processors to determine which features of the mobile device to allow the user to operate by:
determining when the mobile device is operating in a hands-free mode of operation; and
based at least in part on determining when the mobile device is operating in a hands-free mode of operation, allowing one or more features of the mobile device relating to calls.

14. (canceled)

15. The mobile device of claim 1, wherein the machine comprises a motor vehicle and the component comprises a steering component, and wherein the instructions are further executable by the one or more processors to detect the distance of the mobile device from the component by:
identifying the steering component of the motor vehicle utilizing a line of sight feature of the mobile device; and
determining the distance of the mobile device from the steering component utilizing a sonar feature of the mobile device.

16. (canceled)

17. The mobile device of claim 11, wherein the machine comprises a motor vehicle and the safe mode of operation comprises one of (i) the motor vehicle is not operating or (ii) the motor vehicle is operating and is in a park mode in which the motor vehicle is not in gear, and wherein the instructions are further executable by the one or more processors to determine which features of the mobile device to allow the user to operate by:
allowing the user to operate all features of the mobile device when the motor vehicle is determined to be operating in the safe mode of operation.

18. The mobile device of claim 11, wherein the instructions are further executable by the one or more processors to determine which features of the mobile device to allow the user to operate by:
determining which features of the mobile device to allow the user to operate based upon permissions received by the instructions from a database.

19. The mobile device of claim 18, wherein the database is operated by an operator of the wireless communication network.

20. The mobile device of claim 18, wherein the instructions are further executable by the one or more processors to:
receive, from a third party, additional permissions.

21. A mobile device configured for operation in a wireless communication network, the mobile device comprising:
one or more processors;
a non-transitory storage medium; and
instructions stored in the non-transitory storage medium, the instructions being executable by the one or more processors to:
determine when a user of the mobile device is an operator of a machine;
access a database operated by an operator of the wireless communication network that stores one or more permissions provided by the operator of the wireless communication network;
based at least in part on determining when the user is the operator of the machine, determine when the machine is operating in a safe mode of operation; and
based at least in part on i) determining when the machine is operating in the safe mode of operation, and ii) accessing the database operated by the operator of the wireless communication network that stores the one or more permissions provided by the operator of the wireless communication network, determine which features of the mobile device to allow the user to operate.

22. The mobile device of claim 11, wherein determining when the user of the mobile device is the operator of the machine further comprises comparing the distance to a predetermined proximity value associated with an operator position of the machine.

23. The mobile device of claim 11, wherein determining when the user of the mobile device is the operator of the machine further comprises comparing the distance to a predetermined proximity value associated with a passenger position of the machine.
